(19) United States
(12) Patent Application Publication
(10) Pub. No.: US 2025/0153490 A1
(43) Pub. Date: May 15, 2025

(54) DRYER

(71) Applicant: SEIKO EPSON CORPORATION, Tokyo (JP)

(72) Inventors: Tsuneyuki SASAKI, MATSUMOTO-SHI (JP); Manabu SUZUKI, MATSUMOTO-SHI (JP); Seigo MIZUTANI, MATSUMOTO-SHI (JP)

(73) Assignee: SEIKO EPSON CORPORATION, Tokyo (JP)

(21) Appl. No.: 18/941,228

(22) Filed: Nov. 8, 2024

(30) Foreign Application Priority Data
Nov. 10, 2023 (JP) 2023-192335

(51) Int. Cl. B41J 11/00; B41J 15/04

(52) U.S. Cl. CPC B41J 11/0024; B41J 15/046; B41J 15/048

(57) ABSTRACT

A dryer including a heating unit configured to heat a medium, a drying furnace at which the heating unit is disposed and that is configured to dry the medium, and a transport unit configured to transport the medium in the drying furnace, wherein the transport unit includes a first support portion that supports the medium at an inlet side end portion in a transport direction of the medium of the drying furnace, a second support portion that supports the medium at an outlet side end portion in the transport direction of the drying furnace, and a third support portion that supports the medium at a position between the first support portion and the second support portion in a transport path of the medium of the drying furnace, and the third support portion is configured to be movable in a vertical direction.

The present application is based on, and claims priority from JP Application Serial Number 2023-192335, filed Nov. 10, 2023, the disclosure of which is hereby incorporated by reference herein in its entirety.

### BACKGROUND

### 1. Technical Field

The present disclosure relates to a dryer.

### 2. Related Art

In the related art, various types of dryers that dry media have been used. Among them, there is a dryer capable of drying a medium transported by a transport unit. For example, JP 2009-242044 A discloses a heating and drying device including movable rollers as transport units at an inlet side end portion and an outlet side end portion in a transport direction of a medium, in which the movable rollers are variably disposed in an up-down direction.

By applying appropriate tension to the medium transported by the transport unit, for example, a distance from the medium to a heating unit can be finely set, and drying efficiency can be improved. Here, the heating and drying device of JP 2009-242044 A has the movable roller at the inlet side end portion and the movable roller at the outlet side end portion that are variable in the up-down direction, but is not configured to be able to apply appropriate tension to the medium. As described above, in the dryer in the related art capable of drying the medium transported by the transport unit, there was a case in which appropriate tension cannot be applied to the medium in a drying furnace.

### SUMMARY

A dryer of the present disclosure for solving the above-described problems includes a heating unit configured to heat a medium, a drying furnace at which the heating unit is disposed and that is configured to dry the medium, and a transport unit configured to transport the medium in the drying furnace, wherein the transport unit includes a first support portion that supports the medium at an inlet side end portion in a transport direction of the medium of the drying furnace, a second support portion that supports the medium at an outlet side end portion in the transport direction of the drying furnace, and a third support portion that supports the medium at a position between the first support portion and the second support portion in a transport path of the medium of the drying furnace, and the third support portion is configured to be movable in a vertical direction.

### BRIEF DESCRIPTION OF THE DRAWINGS

FIG. 1 is a schematic side view illustrating an example of a printing system including an inkjet printing apparatus and a dryer of Example 1 of the present disclosure.

FIG. 2 is a schematic side view illustrating the dryer of Example 1, and is a diagram illustrating a state in which a third support roller is at a first position, and a medium is set in a drying furnace.

FIG. 3 is a schematic side view illustrating the dryer of Example 1, and is a diagram illustrating a state in which the third support roller is at a second position, and the setting of the medium in the drying furnace is ended.

FIG. 4 is a schematic side view illustrating the dryer of Example 1, and is a diagram illustrating a state in which the third support roller is moved to a third position.

FIG. 5 is a schematic side view illustrating the dryer of Example 1, and is a diagram illustrating a state in which the third support roller is at the third position, and a heating unit is displaced from the state of FIG. 4.

FIG. 6 is a transition diagram when the medium is set in the dryer of Example 1.

FIG. 7 is a transition diagram of an engaging portion in the dryer of Example 1.

FIG. 8 is a schematic side view illustrating a dryer of Example 2, and is a diagram illustrating a state in which a third support roller is at a first position, and a medium is set in a drying furnace.

FIG. 9 is a transition diagram when the medium is set in the dryer of Example 2.

FIG. 10 is a transition diagram of an engaging portion in the dryer of Example 2.

FIG. 11 is a transition diagram when a medium is set in a dryer of Example 3.

FIG. 12 is a transition diagram when a medium is set in a dryer of Example 4.

FIG. 13 is a perspective view of an engaging portion in the dryer of Example 4.

FIG. 14 is a side view of the engaging portion in the dryer of Example 4.

### DESCRIPTION OF EMBODIMENTS

First, an overview of the present disclosure will be described.

A dryer of a first aspect of the present disclosure for solving the above-described problems includes a heating unit configured to heat a medium, a drying furnace at which the heating unit is disposed and that is configured to dry the medium, and a transport unit configured to transport the medium in the drying furnace, wherein the transport unit includes a first support portion that supports the medium at an inlet side end portion in a transport direction of the medium of the drying furnace, a second support portion that supports the medium at an outlet side end portion in the transport direction of the drying furnace, and a third support portion that supports the medium at a position between the first support portion and the second support portion in a transport path of the medium of the drying furnace, and the third support portion is configured to be movable in a vertical direction.

According to the present aspect, the transport unit includes the first support portion that supports the medium at the inlet side end portion, the second support portion that supports the medium at the outlet side end portion, and the third support portion that supports the medium at a position between the first support portion and the second support portion in the transport path of the medium in the drying furnace, and the third support portion is configured to be movable in the vertical direction. Therefore, by changing a disposition of the third support portion with respect to the first support portion and the second support portion, it is possible to apply appropriate tension to the medium in the drying furnace. Furthermore, since it is possible to set the medium in the drying furnace in a state in which an interval between the third support portion and the heating unit is increased, it is possible to improve ease of setting the medium in the drying furnace.

The dryer according to a second aspect of the present disclosure is an aspect dependent on the first aspect, that includes a reflecting plate disposed at a position facing the heating unit and configured to reflect heat generated by the heating unit, wherein the reflecting plate is configured to be permitted to support the medium.

According to the present aspect, the reflecting plate that is disposed at a position facing the heating unit and reflects the heat generated by the heating unit is included, and the reflecting plate is configured to be capable of supporting the medium. That is, the reflecting plate that also serves as a medium support portion is included. Therefore, drying efficiency is improved, and the medium can be particularly suitably supported in the drying furnace.

The dryer of a third aspect of the present disclosure is an aspect dependent on the second aspect, that includes, as the reflecting plate, a first reflecting plate disposed at a position between the first support portion and the third support portion and a second reflecting plate disposed at a position between the third support portion and the second support portion, wherein at least one of the first reflecting plate and the second reflecting plate is configured to be displaceable according to a position of the third support portion.

According to the present aspect, the reflecting plate includes the first reflecting plate disposed at a position between the first support portion and the third support portion and the second reflecting plate disposed at a position between the third support portion and the second support portion, and at least one of the first reflecting plate and the second reflecting plate is configured to be displaceable according to the position of the third support portion. With such a configuration, drying efficiency can be particularly suitably improved and the medium can be particularly suitably supported in the drying furnace.

The dryer of a fourth aspect of the present disclosure is an aspect dependent on any one of the first to third aspects, that includes a medium movement assisting portion configured to assist movement of the medium from an inlet side in the transport direction to an outlet side in the transport direction in the drying furnace.

According to the present aspect, the medium movement assisting portion is included that assists the movement of the medium from the inlet side in the transport direction to the outlet side in the transport direction in the drying furnace. Therefore, when the medium is set in the drying furnace, it is possible to easily move the medium from the inlet side in the transport direction to the outlet side in the transport direction in the drying furnace.

The dryer of a fifth aspect of the present disclosure is an aspect dependent of the third aspect, that includes a first medium movement assisting portion configured to assist movement of the medium from the first support portion side to the third support portion side along the first reflecting plate in the drying furnace, and a second medium movement assisting portion configured to assist movement of the medium from the third support portion side to the second support portion side along the second reflecting plate in the drying furnace, wherein the first medium movement assisting portion and the second medium movement assisting portion are configured to be permitted to deliver the medium at a position between the first reflecting plate and the second reflecting plate.

According to the present aspect, the first medium movement assisting portion that assists the movement of the medium from the first support portion side to the third support portion side along the first reflecting plate in the drying furnace, and the second medium movement assisting portion that assists the movement of the medium from the third support portion side to the second support portion side along the second reflecting plate in the drying furnace are included, and the first medium movement assisting portion and the second medium movement assisting portion are configured to be capable of delivering the medium at a position between the first reflecting plate and the second reflecting plate. Therefore, when the medium is set in the drying furnace, it is possible to easily move the medium from the inlet side in the transport direction to the outlet side in the transport direction in the drying furnace.

The dryer of a sixth aspect of the present disclosure is an aspect dependent on the third aspect, that includes a medium movement assisting portion configured to assist movement of the medium from an inlet side in the transport direction to an outlet side in the transport direction in the drying furnace, wherein the first reflecting plate is permitted to be disposed to be lowered as viewed from the first support portion side to the third support portion side, the second reflecting plate is permitted to be disposed to be lowered as viewed from the third support portion side to the second support portion side, and the medium movement assisting portion is permitted to be moved from the inlet side in the transport direction to the outlet side in the transport direction by using gravity while holding the medium.

According to the present aspect, the medium movement assisting portion can be moved from the inlet side in the transport direction to the outlet side in the transport direction by using gravity while holding the medium. For this reason, when the medium is set in the drying furnace, it is possible to particularly easily move the medium from the inlet side in the transport direction to the outlet side in the transport direction in the drying furnace by using gravity.

The dryer of a seventh aspect of the present disclosure is an aspect dependent of any one of the first to third aspects, that includes a heating unit displacement unit configured to displace at least one of a position and posture of the heating unit, wherein the heating unit displacement unit displaces the heating unit based on the position of the third support portion.

According to the present aspect, the heating unit displacement unit that displaces at least one of the position and the posture of the heating unit is included, and the heating unit displacement unit displaces the heating unit based on the position of the third support portion. Therefore, it is possible to prevent the heating unit from becoming an obstacle when the medium is set in the drying furnace, and it is possible to bring the heating unit close to the medium when the medium is dried.

The dryer of an eighth aspect of the present disclosure is an aspect dependent on any one of the first to third aspects, that includes an exhaust port at the drying furnace, wherein as the heating unit, a first heating unit located upstream of the exhaust port in the transport direction and a second heating unit located downstream of the exhaust port in the transport direction are included.

According to the present aspect, since the exhaust port is included at the drying furnace, vapor in the drying furnace can be discharged by ventilating an inside of the drying furnace, and drying efficiency can be improved. Furthermore, since the heating units are provided both upstream and downstream of the exhaust port in the transport direction, the drying efficiency can be particularly improved.

The dryer of a ninth aspect of the present disclosure is an aspect dependent on any one of the first to third aspects, that includes a third support portion position adjustment unit configured to adjust a position of the third support portion in a vertical direction, wherein the third support portion position adjustment unit adjusts the position of the third support portion in the vertical direction according to a type of the medium.

According to the present aspect, the third support portion position adjustment unit adjusts the position of the third support portion in the vertical direction according to the type of the medium. Since there is a medium which is weak against heat, an appropriate distance to the heating unit when the medium is dried depends on the type of the medium, but the distance can be optimized.

The dryer of a tenth aspect of the present disclosure is an aspect dependent on any one of the first to third aspects, that includes a third support portion position adjustment unit configured to adjust a position of the third support portion in a vertical direction, wherein the third support portion position adjustment unit adjusts the position of the third support portion in the vertical direction according to a transport state of the medium.

According to the present aspect, the third support portion position adjustment unit adjusts the position of the third support portion in the vertical direction according to the transport state of the medium. Even when heated at the same temperature, the medium may be brought into different transport states in which the medium expands, contracts, and the like depending on the type of the medium, thus an appropriate distance to the heating unit when the medium is dried depends on the transport state of the medium, but the distance can be optimized.

The dryer of an eleventh aspect of the present disclosure is an aspect dependent on any one of the first to third aspects, wherein the drying furnace is provided with a window portion through which the third support portion is visible from outside.

According to the present aspect, the drying furnace is provided with the window portion through which the third support portion is visible from outside. Therefore, an operator can visually check the position of the third support portion through the window portion.

The dryer of a twelfth aspect of the disclosure is an aspect dependent on the tenth aspect, wherein the third support portion position adjustment unit performs adjustment such that at least a part of the third support portion is at a position farther from the heating unit when the medium is not transported than when the medium is transported.

According to the present aspect, the third support portion position adjustment unit performs adjustment such that at least a part of the third support portion is at a position farther from the heating unit when the medium is not transported than when the medium is transported. For this reason, it is possible to suppress damage to the medium due to heating of the medium when the medium is not transported in a state in which heating is not necessary.

### Example 1

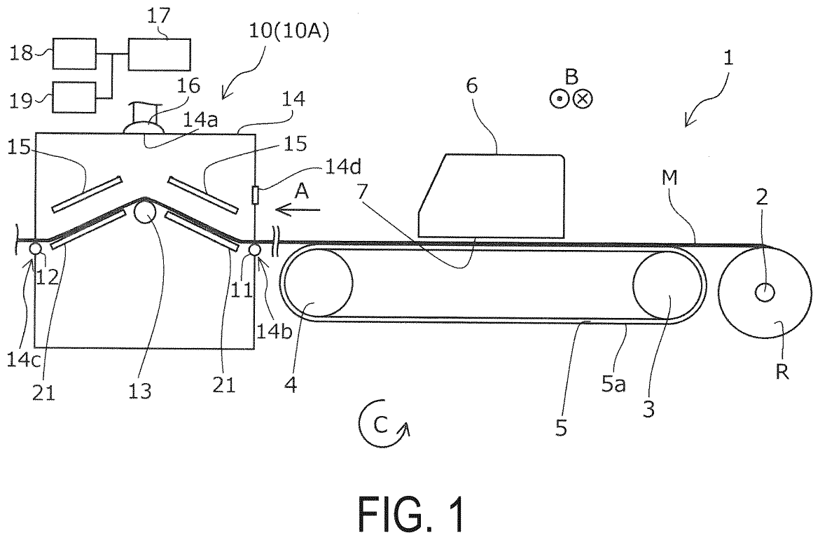

Hereinafter, an embodiment according to the present disclosure will be described with reference to the accompanying drawings. First, an outline of a printing system including an inkjet printing apparatus 1 as an example and a dryer 10A of Example 1 as an example of a dryer 10 of the present disclosure will be described with reference to FIG. 1. Note that in FIG. 1, the dryer 10A of the present example is the example used in the printing system that is used together with the inkjet printing apparatus 1, however, the dryer 10A may be used as a printing system that is used together with a printing apparatus other than the inkjet printing apparatus, or may be used alone separately from the printing apparatus.

As illustrated in FIG. 1, the inkjet printing apparatus 1 used in the printing system of the present example includes a holding unit 2 capable of rotatably holding a roll body R in which a medium M such as cloth is wound in a roll shape. The holding unit 2 holds the roll body R through which a paper tube constituting a rotary shaft of the roll body R passes. The holding unit 2 can rotate in a rotation direction C to feed the medium M from the roll body R to a transporting belt 5.

The inkjet printing apparatus 1 of the present example includes a driven roller 3 located upstream in a transport direction A, a driving roller 4 located downstream in the transport direction A, and the transporting belt 5, which is an endless belt stretched across the driven roller 3 and the driving roller 4. Here, the transporting belt 5 is an adhesive belt including an outer circumferential surface 5a in which a support face of the medium M which is an outer face is applied with an adhesive.

As illustrated in FIG. 1, the medium M is supported and transported by the transporting belt 5 in a state in which the medium M is attached to the outer circumferential surface 5a. In the inkjet printing apparatus 1 of the present example, a medium support region that supports the medium M in the transporting belt 5 is an upper-side region stretched across the driven roller 3 and the driving roller 4. Further, the driving roller 4 is a roller that rotates under driving force from a motor, which is not illustrated, in the rotation direction C, and the driven roller 3 is a roller that rotates in response to the rotation of the transporting belt 5 when the driving roller 4 is rotated.

In addition, the inkjet printing apparatus 1 of the present example includes a carriage 6 capable of reciprocating in a width direction B of the transporting belt 5, and a head 7 attached to the carriage 6. The head 7 is a printing unit capable of forming an image by ejecting a liquid ink onto the medium M transported in the transport direction A based on print data.

Then, the inkjet printing apparatus 1 of the present example is capable of forming an image by ejecting the ink from the head 7 onto the transported medium M while reciprocating the carriage 6 in the width direction B, which intersects with the transport direction A. By including the carriage 6 configured in this manner, the inkjet printing apparatus 1 of the present example can form a desired image on the medium M by repeating the transport of the medium M in the transport direction A by a predetermined transport amount, and the ejection of the ink while moving the carriage 6 in the width direction B while the medium M is stopped.

Upon being discharged from the inkjet printing apparatus 1 of the present example, the medium M on which an image is formed by the ink being ejected from the head 7 is fed to the dryer 10A of the present example that volatilizes components in the ink ejected onto the medium M, provided in stages following the inkjet printing apparatus 1 of the present example. In this way, the dryer 10A of the present example constitutes the printing system together with the inkjet printing apparatus 1. However, although the description is repeated, the dryer 10 of the present example may be used alone separately from the inkjet printing apparatus 1.

Here, a printable material may be used as the medium M. The term “printable material” refers to a fabric, a garment, and other clothing products on which printing can be performed. Fabrics includes natural fibers such as cotton, silk and wool, chemical fibers such as nylon, or composite fibers of natural fibers and chemical fibers such as woven cloths, knit fabrics, and non-woven cloths. Garments and other clothing products include sewn products, such as a T-shirt, handkerchief, scarf, towel, handbag, fabric bag, and furniture-related products including a curtain, sheet, and bed cover, as well as fabric before and after cutting to serve as pieces of cloth before sewing. However, in addition to the printable materials described above, special paper for ink-jet recording, such as plain paper, pure paper, and glossy paper may be used.

As illustrated in FIG. 1, the dryer 10A of the present example includes a heating unit 15 that heats the medium M, a drying furnace 14 in which the heating unit 15 is disposed and that dries the medium M, and a first support roller 11, a second support roller 12, and a third support roller 13 as a transport unit that transports the medium M in the drying furnace 14. Note that although the heating unit 15 of the present example includes a plurality of infrared irradiation units arranged in a planar shape, the heating unit 15 is not limited to such a configuration. The first support roller 11 supports the medium M at an inlet side end portion 14b of the drying furnace 14 in the transport direction A as a first support portion. The second support roller 12 supports the medium M at an outlet side end portion 14c of the drying furnace 14 in the transport direction A as a second support portion. The third support roller 13 is configured to be able to support the medium M at a position between the first support roller 11 and the second support roller 12 in a transport path of the medium M in the drying furnace 14 as a third support portion.

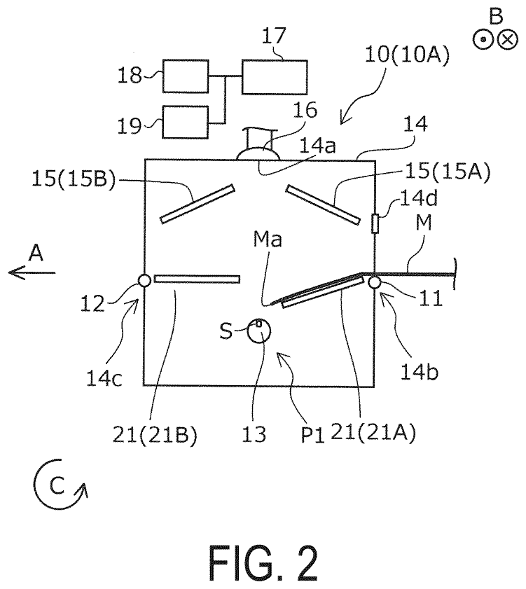

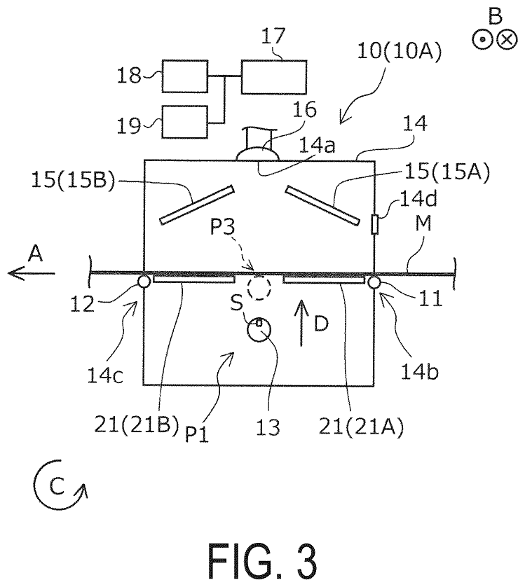

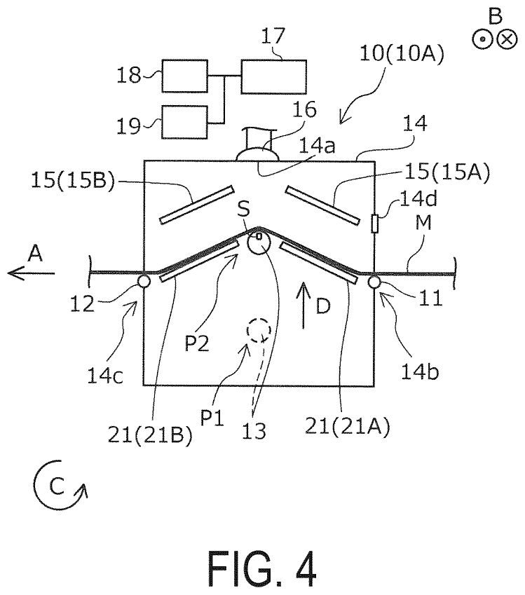

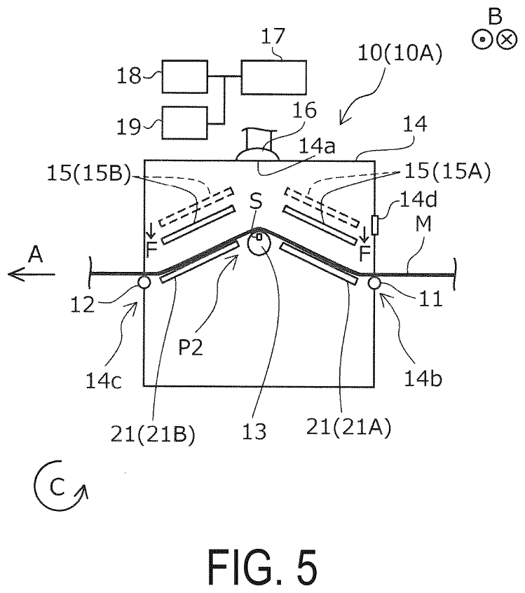

With reference to FIG. 2 to FIG. 5 in addition to FIG. 1, the dryer 10A of the present example will be described below in further detail. The third support roller 13 is configured to be movable in a vertical direction. To be specific, the third support roller 13 is configured to be movable between a first position P1 that is a position lower than the first support roller 11 and the second support roller 12 in the vertical direction as illustrated in FIGS. 2 and 3, and a second position P2 that is a position higher than the first support roller 11 and the second support roller 12 in the vertical direction as illustrated in FIGS. 4 and 5. By moving the third support roller 13 from the first position P1 in a direction D, the third support roller 13 can be disposed at the second position P2.

As described above, the dryer 10A of the present example includes, as the transport unit, the first support roller 11 that supports the medium M at the inlet side end portion 14b, the second support roller 12 that supports the medium M at the outlet side end portion 14c, and the third support roller 13 that supports the medium M at a position between the first support roller 11 and the second support roller 12 in the transport path of the medium M in the drying furnace 14 as illustrated in FIGS. 4 and 5. It is possible to apply tension to the medium M by displacing the third support roller 13 from a state illustrated in FIG. 3 to a state illustrated in FIG. 4. That is, in the dryer 10A of the present example, appropriate tension can be applied to the medium M in the drying furnace 14 by changing the disposition of the third support roller 13 with respect to the first support roller 11 and the second support roller 12.

Note that in the dryer 10A of the present example, the medium M can also be transported in a state in which the third support roller 13 is at a third position P3 indicated by a dashed line in FIG. 3. By transporting the medium M in the state in which the third support roller 13 is at the third position P3, it is possible to transport the medium M without a problem even when the medium M that is easily stretched by applying tension is used.

Furthermore, in the dryer 10A of the present example, when the medium M is set, the third support roller 13 can be disposed in a state illustrated in FIG. 2, and further the medium M can be moved until a leading end Ma of the medium M comes near a center in the drying furnace 14. That is, it is possible to set the medium M in the drying furnace 14 in a state in which an interval between the third support roller 13 and the heating unit 15 is increased. Therefore, with the dryer 10A of the present example, ease of setting the medium M in the drying furnace 14 can be improved.

As illustrated in FIGS. 1 to 5, the dryer 10A of the present example includes a reflecting plate 21 that is disposed at a position facing the heating unit 15 and reflects heat generated by the heating unit 15. The reflecting plate 21 is configured to be capable of supporting the medium M. That is, the dryer 10A of the present example includes the reflecting plate 21 which also serves as a medium support portion. For this reason, the dryer 10A of the present example has an improved drying effect, and can particularly suitably support the medium M in the drying furnace 14.

Specifically, as illustrated in FIGS. 2 to 5, the dryer 10A of the present example includes, as the reflecting plate 21, a first reflecting plate 21A disposed at a position between the first support roller 11 and the third support roller 13, and a second reflecting plate 21B disposed at a position between the third support roller 13 and the second support roller 12 are included. Then, as illustrated in FIGS. 2 to 5, the first reflecting plate 21A is configured to be displaceable according to a position of the third support roller 13. On the other hand, the second reflecting plate 21B is configured to be caught by the first reflecting plate 21A, and is configured to be displaceable according to a position of the first reflecting plate 21A.

In this way, at least one of the first reflecting plate 21A and the second reflecting plate 21B is configured to be displaceable according to the position of the third support roller 13, and thus it is possible to make the heating unit 15 and a support position of the medium M suitable, it is possible to particularly suitably improve drying efficiency, and it is possible to particularly suitably support the medium M in the drying furnace 14. In particular, since the first reflecting plate 21A is configured to be displaceable according to the position of the third support roller 13, it is possible to improve ease of setting when the medium M is set in the drying furnace 14.

As illustrated in FIGS. 1 to 5, the dryer 10 of the present example includes a control unit 17 including a CPU, a storage unit, and the like, a third support roller position adjustment unit 18 that adjusts the position of the third support roller 13 in the vertical direction under the control of the control unit 17, and a heating unit displacement unit 19 that displaces at least one of a position and posture of the heating unit 15. As illustrated in FIGS. 2 and 3, when the third support roller 13 is at the first position P1, the heating unit 15 is located on an upper side. However, when the third support roller 13 moves to the second position P2 as illustrated in FIG. 4, the position of the heating unit 15 can be moved downward along a direction F accordingly as illustrated in FIG. 5.

As described above, as can be seen by comparing FIGS. 2 to 5, the heating unit displacement unit 19 can displace the heating unit 15 based on the position of the third support roller 13. Therefore, in the dryer 10 of the present example, it is possible to prevent the heating unit 15 from becoming an obstacle when the medium M is set in the drying furnace 14, and it is possible to bring the heating unit 15 close to the medium M when the medium M is dried.

To be specific, in the dryer 10A of the present example, the third support roller 13 is moved in the direction D from a state of being positioned at the first position P1 illustrated in FIGS. 2 and 3 to a state of being positioned at the second position P2 illustrated in FIG. 4 under the control of the control unit 17. Thereafter, the heating unit 15 is moved linearly as a whole in the direction F from the state illustrated in FIG. 4 to a state illustrated in FIG. 5. However, the method of displacing the heating unit 15 is not limited to the linear movement of the heating unit 15 as a whole, and may be a method of displacing at least one of the position and the posture by a method other than the linear movement as a whole, such as rotating the heating unit 15 and horizontally disposing the heating unit 15.

In addition, in the dryer 10A of the present example, in a state in which the medium M is not transported such as when a power is turned off, a distance between the medium M and the heating unit 15 can be increased by locating the heating unit 15 on the upper side, disposing the third support roller 13 at the first position P1, locating the reflecting plate 21 on a lower side, and the like. In this way, in the state in which the medium M is not transported, it is possible to suppress damage to the medium M due to application of unnecessary heat to the medium M.

From another point of view, in the dryer 10A of the present example, the third support roller position adjustment unit 18 as the third support portion position adjustment unit can perform adjustment such that at least a part of the third support roller 13 is at a position farther from the heating unit 15 when the medium M is not transported than when the medium M is transported. For this reason, in the dryer 10A of the present example, it is possible to suppress damage to the medium M due to heating of the medium M when the medium is not transported in a state in which heating is not necessary.

As illustrated in FIGS. 1 to 5, the dryer 10 of the present example includes an exhaust port 14a at the drying furnace 14. Additionally, as illustrated in FIGS. 2 to 5, as the heating unit 15, a first heating unit 15A located upstream of the exhaust port 14A in the transport direction A and a second heating unit 15B located downstream of the exhaust port 14a in the transport direction A are included.

In the dryer 10 of the present example, since the drying furnace 14 is provided with the exhaust port 14a as described above, vapor in the drying furnace 14 can be discharged by ventilating an inside of the drying furnace 14, and the drying efficiency can be improved. Furthermore, in the dryer 10 of the present example, the heating units 15 are provided both upstream and downstream of the exhaust port 14a in the transport direction, and the drying efficiency can be particularly improved. In particular, by adopting a configuration in which the first heating unit 15A and the second heating unit 15B are located on the upper side as the exhaust port 14a is approached, and by adopting a configuration in which the first reflecting plate 21A and the second reflecting plate 21B are also located on the upper side as the exhaust port 14a is approached, the vapor can be discharged particularly efficiently by a chimney effect, and the drying efficiency can be particularly improved.

As illustrated in FIGS. 1 to 5, the dryer 10 of the present example is coupled to a duct including an exhaust fan 16 at the exhaust port 14a. Therefore, the configuration is adopted in which the drying efficiency can be particularly improved, but the present disclosure is not limited to such a configuration.

As described above, the dryer 10 of the present example includes the third support roller position adjustment unit 18 that adjusts the position of the third support roller 13 in the vertical direction. The third support roller position adjustment unit 18 can adjust the position of the third support roller 13 in the vertical direction according to a type of the medium M to be used under the control of the control unit 17.

Since the medium M is weak against heat in some cases, an appropriate distance to the heating unit 15 when the medium M is dried depends on the type of the medium M, however, the distance can be optimized by adopting the configuration of the dryer 10 of the present example. A configuration may be adopted in which the medium M to be used is input to the dryer 10 from a PC (not illustrated) or the like, but a configuration may be adopted in which the dryer 10 is provided with an operation panel and the medium M is input from the operation panel or the like.

In the dryer 10 of the present example, as illustrated in FIGS. 2 to 5, the third support roller 13 is provided with a sensor S capable of measuring a stress of the medium M. The third support roller position adjustment unit 18 can adjust the position of the third support roller 13 in the vertical direction according to the stress of the medium M as an example of a transport state of the medium M under the control of the control unit 17. In other words, fine adjustment of the second position P2 in the up-down direction of the third support roller 13 in the vertical direction can be automatically performed according to the stress of the medium M under the control of the control unit 17. Even when heated at the same temperature, the medium M may be brought into different transport states in which the medium M expands, contracts, and the like depending on the type of the medium M, thus an appropriate distance to the heating unit 15 when the medium M is dried depends on the transport state of the medium M, but the distance can be optimized.

Note that in the present example, the transport state of the medium M is detected by the sensor S capable of measuring the stress of the medium M, but the transport state of the medium M is not particularly limited. As devices that measure the transport state of the medium M, it is possible to use a device that images the medium M, a device that measures an amount of vapor in order to detect a dry state of the medium M, a device that measures a transport sound of the medium M, and the like. Furthermore, a configuration may be adopted in which an amount of ink ejected onto the medium M is calculated from print data, and a transport state of the medium M may be determined based on the amount of ink.

As illustrated in FIGS. 1 to 5, in the dryer 10A of the present example, the drying furnace 14 is provided with a window portion 14d through which the third support roller 13 is visible from outside. Therefore, an operator can visually check the position of the third support roller 13 through the window portion 14d.

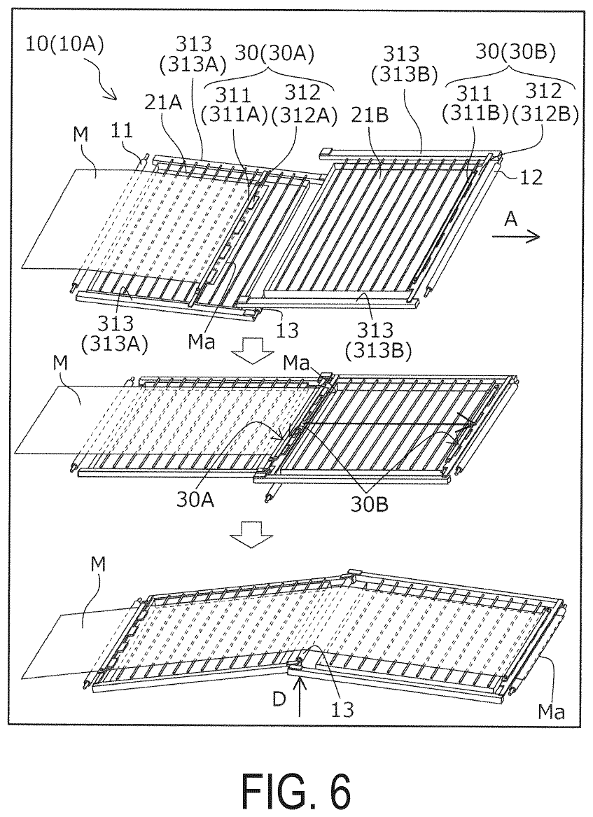

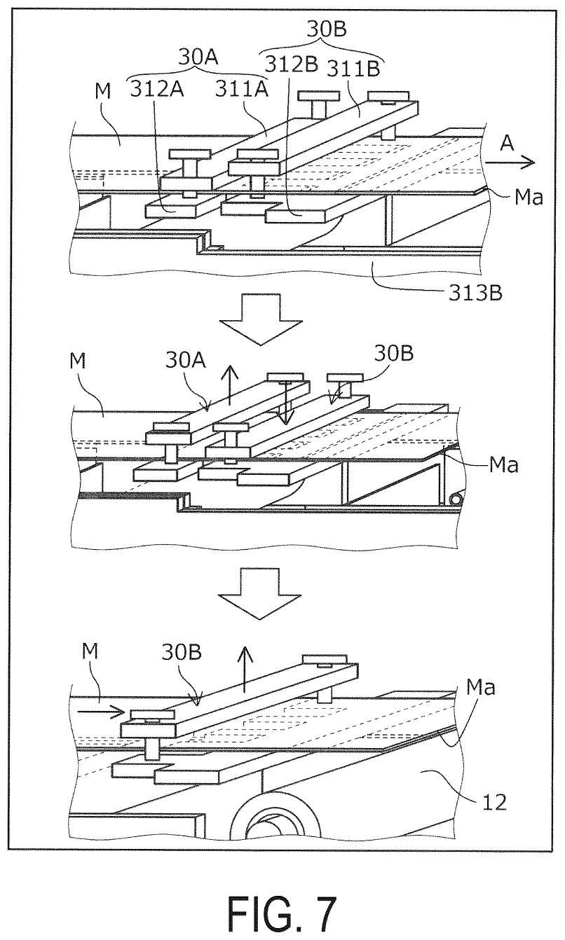

Next, a transition when the medium M is set in the dryer 10A of the present example will be described with reference to FIG. 6 and FIG. 7. As illustrated in FIGS. 6 and 7, the dryer 10A of the present example includes an engaging portion 30 that is movable along the reflecting plate 21 while sandwiching the medium M. The engaging portion 30 includes a base portion 312 which is movable in the transport direction A and a direction opposite to the transport direction A along a rail portion 313 along the reflecting plate 21, and a movable portion 311 which is movable in the up-down direction with respect to the base portion 312.

Specifically, as the engaging portion 30, a first engaging portion 30A is included that includes a first base portion 312A movable along a first rail portion 313A along the first reflecting plate 21A, and a first movable portion 311A movable with respect to the first base portion 312A. Further, as the engaging portion 30, a second engaging portion 30B is included that includes a second base portion 312B movable along the first rail portion 313A along the second reflecting plate 21B, and a second movable portion 311B movable with respect to the second base portion 312B.

When the medium M is set in the dryer 10A of the present example, first, as illustrated in a state diagram in an upper stage of FIG. 6, the medium M is sandwiched between the first base portion 312A and the first movable portion 311A of the first engaging portion 30A and is moved from the first support roller 11 side to the third support roller 13 side along the transport direction A. Next, as illustrated in a state diagram in a middle stage of FIG. 6, in a vicinity of the third support roller 13, a state in which the medium M is sandwiched between the first base portion 312A and the first movable portion 311A of the first engaging portion 30A is changed to a state in which the medium M is sandwiched between the second base portion 312B and the second movable portion 311B of the second engaging portion 30B. This operation is performed by an operator so that the state in which the medium M is sandwiched by the first engaging portion 30A as illustrated in a state diagram in an upper stage of FIG. 7 is changed to the state in which the medium M is sandwiched by the second engaging portion 30B as illustrated in a state diagram in a middle stage of FIG. 7. Note that the first base portion 312A of the first engaging portion 30A and the second base portion 312B of the second engaging portion 30B are provided with uneven portions in each of which protrusions and recesses are formed in a direction in which the uneven portions face each other so as to be engaged with each other.

After the state in which the medium M is sandwiched between the first base portion 312A and the first movable portion 311A of the first engaging portion 30A as illustrated in the state diagram in the upper stage of FIG. 7 is changed to the state in which the medium M is sandwiched between the second base portion 312B and the second movable portion 311B of the second engaging portion 30B as illustrated in the state diagram in the middle stage of FIG. 7, the first engaging portion 30A is moved to a vicinity of the first support roller 11 in the direction opposite to the transport direction A, and the second engaging portion 30B in a state of sandwiching the medium M is moved to a vicinity of the second support roller 12 in the transport direction A, as illustrated in a state diagram in a lower stage of FIG. 6. Thereafter, as illustrated in a state diagram in a lower stage of FIG. 7, the second movable portion 311B is pulled upward with respect to the second base portion 312B, and the medium M is removed from the second engaging portion 30B.

As described above, the dryer 10A of the present example includes the engaging portion 30 as a medium movement assisting portion that assists movement of the medium M in the drying furnace 14 from an inlet side in the transport direction A to an outlet side in the transport direction A. Therefore, in the dryer 10A of the present example, when the medium M is set in the drying furnace 14, the medium M can be easily moved from the inlet side in the transport direction A to the outlet side in the transport direction A in the drying furnace 14.

Specifically, the dryer 10A of the present example includes the first engaging portion 30A as a first medium movement assisting portion that assists movement of the medium M from the first support roller 11 side to the third support roller 13 side along the first reflecting plate 21A in the drying furnace 14, and the second engaging portion 30B as a second medium movement assisting portion that assists movement of the medium M from the third support roller 13 side to the second support roller 12 side along the second reflecting plate 21B in the drying furnace 14. Then, the first engaging portion 30A and the second engaging portion 30B are configured to be able to deliver the medium M at a position between the first reflecting plate 21A and the second reflecting plate 21B. Therefore, in the dryer 10A of the present example, when the medium M is set in the drying furnace 14, the medium M can be easily moved from the inlet side in the transport direction A to the outlet side in the transport direction A in the drying furnace 14.

### Example 2

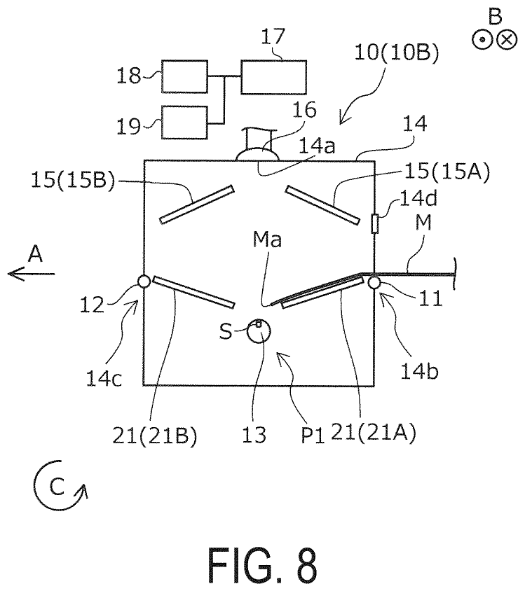

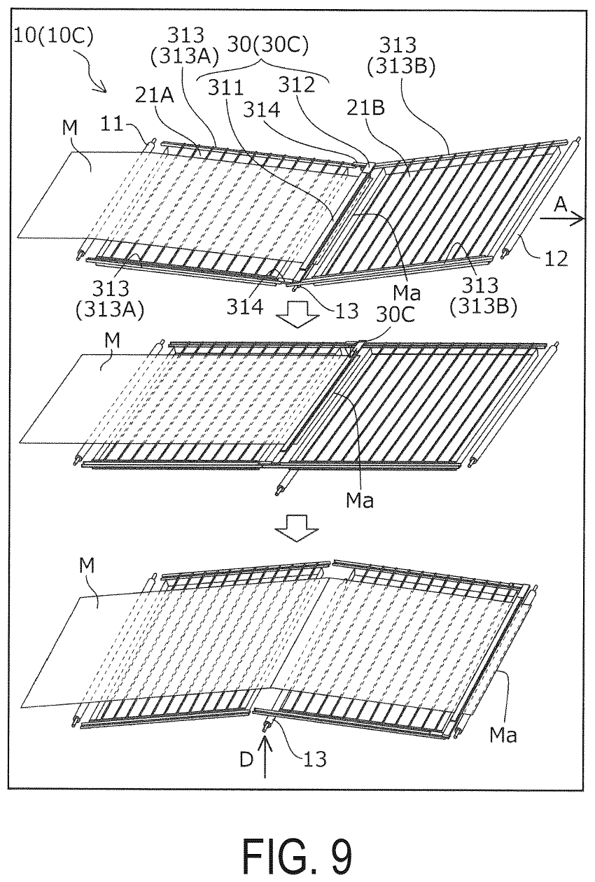

Next, a dryer 10B of Example 2 will be described using FIGS. 8 to 10. Note that FIG. 8 is a diagram corresponding to FIG. 2 in the dryer device 10A of Example 1, and FIG. 9 is a diagram corresponding to FIG. 6 in the dryer 10A of Example 1. In FIGS. 8 to 10, components common to those in Example 1 described above are denoted with the same reference symbols, and detailed description thereof is omitted. Here, the dryer 10B of the present example has a similar configuration to that of the dryer 10A of Example 1 except for points described below. Therefore, the dryer 10B of the present example has similar features to those of the dryer 10A of Example 1 except for points other than the points described below.

As illustrated in FIG. 8, the dryer 10B of the present example is configured such that the first reflecting plate 21A and the second reflecting plate 21B can be displaced in the up-down direction in synchronization with each other. The dryer 10B of the present example includes only one engaging portion 30 as an engaging portion 30C, which is movable from the first support roller 11 side to the third support roller 13 side along the transport direction A and is movable from the third support roller 13 side to the second support roller 12 side along the transport direction A.

When the medium M is set in the dryer 10B of the present example, first, as illustrated in a state diagram in an upper stage of FIG. 9, the medium M is sandwiched between the base portion 312 and the movable portion 311 of the first engaging portion 30C and is moved from the first support roller 11 side to the third support roller 13 side along the transport direction A. At this time, it is possible to automatically move the medium M along the transport direction A using a weight of the engaging portion 30C. Next, as illustrated in a state diagram in a middle stage of FIG. 9, in a vicinity of the third support roller 13, a state in which the engaging portion 30C is supported only by the first rail portion 313A is changed to a state in which the engaging portion 30C is supported by both the first rail portion 313A and a second rail portion 313B.

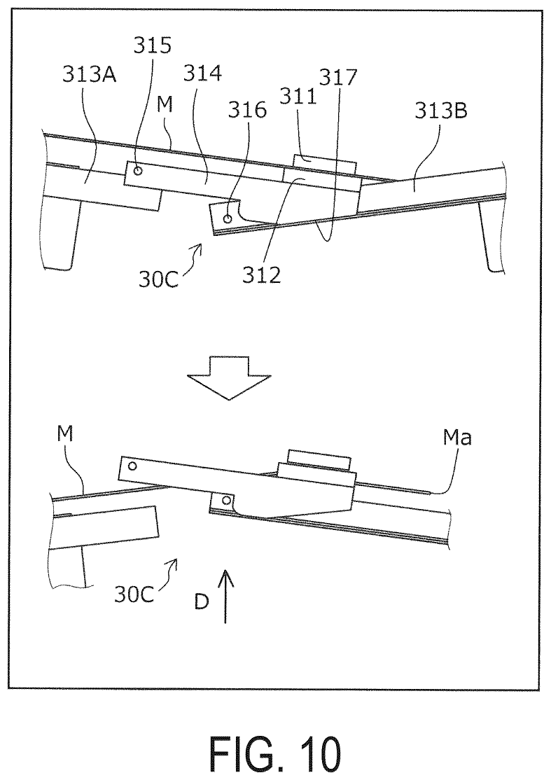

As illustrated in a state diagram in an upper state of FIG. 10, the base portion 312 of the engaging portion 30C is provided with a bridging portion 314. The bridging portion 314 is provided with a slope portion 317 capable of abutting on the second rail portion 313B and a pin 315 provided so that the bridging portion 314 is engaged with the first rail portion 313A even in a state in which the slope portion 317 abuts on the second rail portion 313B. With such a configuration, the engaging portion 30C is brought into a state of being automatically engaged with both the first rail portion 313A and the second rail portion 313B in the vicinity of the third support roller 13.

After the engaging portion 30C is brought into the state of being supported by both the first rail portion 313A and the second rail portion 313B, the third support roller 13 is moved upward to bring the engaging portion 30C into a state of being supported only by the second rail portion 313B as illustrated in a state diagram in a lower state of FIG. 10. Note that a reverse slip prevention pin 316 is formed at the second rail portion 313B, and when the second rail portion 313B is displaced, reverse slippage of the engaging portion 30C in the direction opposite to the transport direction A can be suppressed. Here, by displacing the second reflecting plate 21B together with the second rail portion 313B to change the state diagram in the middle stage of FIG. 9 to a state diagram in a lower stage of FIG. 9, it is possible to automatically move the medium M along the transport direction A using the weight of the engaging portion 30C.

That is, in the dryer 10B of the present example, the first reflecting plate 21A can be disposed to be lowered as viewed from the first support roller 11 side to the third support roller 13 side, and the second reflecting plate 21B can be disposed to be lowered as viewed from the third support roller 13 side to the second support roller 12 side. Then, the engaging portion 30C can move the medium from the inlet side in the transport direction A to the outlet side in the transport direction A using gravity associated with a mass of the engaging portion 30C while holding the medium M. Therefore, in the dryer 10B of the present example, when the medium M is set in the drying furnace 14, the medium M can be particularly easily moved, using gravity, from the inlet side in the transport direction A to the outlet side in the transport direction A in the drying furnace 14.

### Example 3

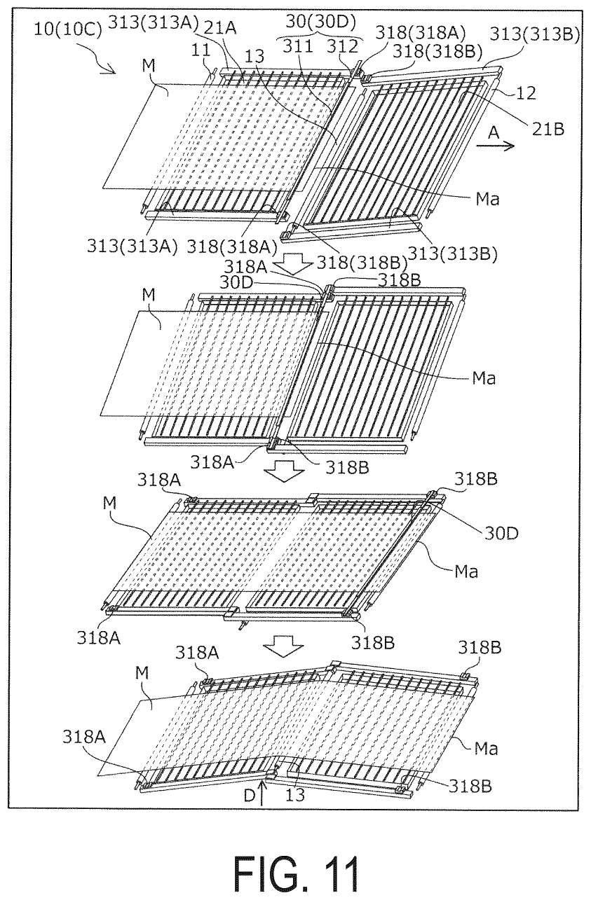

Next, a dryer 10C of Example 3 will be described using FIG. 11. Note that FIG. 11 is a diagram corresponding to FIG. 6 in the dryer 10A of Example 1. In FIG. 11, components common to those in Example 1 and Example 2 described above are denoted with the same reference symbols, and detailed description thereof is omitted. Here, the dryer 10C of the present example has a similar configuration to those of the dryers 10 of Example 1 and Example 2 except for points described below. Therefore, the dryer 10C of the present example has similar features as those of the dryers 10 of Example 1 and Example 2 except for points other than the points described below.

As illustrated in FIG. 11, similarly to the dryer 10B in Example 2, the dryer 10C of the present example also includes only one engaging portion 30 as an engaging portion 30D, which is movable from the first support roller 11 side to the third support roller 13 side along the transport direction A and is movable from the third support roller 13 side to the second support roller 12 side along the transport direction A. Then, both the first rail portion 313A and the second rail portion 313B are provided with engaging portion supporting and moving portions 318 that are each movable along the rail portion 313 while holding the engaging portion 30D.

As illustrated in a state diagram at a top of FIG. 11, in the dryer 10C of the present example, while a first engaging portion supporting and moving portion 318A provided at the first rail portion 313A is caused to support the engaging portion 30D sandwiching the medium M, the first engaging portion supporting and moving portion 318A can be moved along the transport direction A from the first support roller 11 side to the third support roller 13 side together with the engaging portion 30D sandwiching the medium M. Then, as illustrated in a second state diagram from the top of FIG. 11, by displacing the second reflecting plate 21B to horizontally align the first rail portion 313A and the second rail portion 313B, the engaging portion 30D can be delivered from the first engaging portion supporting and moving portion 318A to a second engaging portion supporting and moving portion 318B. Then, as illustrated in a third state diagram from the top of FIG. 11, the engaging portion 30D sandwiching the medium M can be moved along the transport direction A together with the second engaging portion supporting and moving portion 318B. Then, subsequently, as illustrated in a state diagram at a bottom of FIG. 11, appropriate tension can be applied to the medium M by displacing the first reflecting plate 21A and the second reflecting plate 21B.

### Example 4

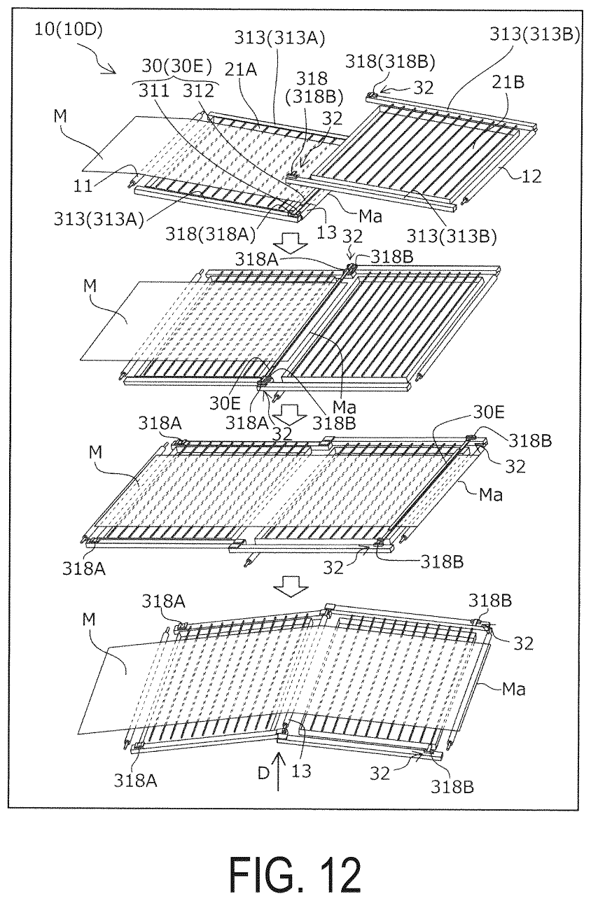

Next, a dryer 10D of Example 4 will be described using FIGS. 12 to 14. Note that FIG. 12 is a diagram corresponding to FIG. 6 in the dryer 10A of Example 1. In FIGS. 12 to 14, components common to those in Example 1 to Example 3 described above are denoted with the same reference symbols, and detailed description thereof is omitted. Here, the dryer 10D of the present example has a similar configuration to those of the dryers 10 of Example 1 to Example 3 except for points described below. Therefore, the dryer 10D of the present example has similar features as those of the dryers 10 of Example 1 to Example 3 except for points other than the points described below.

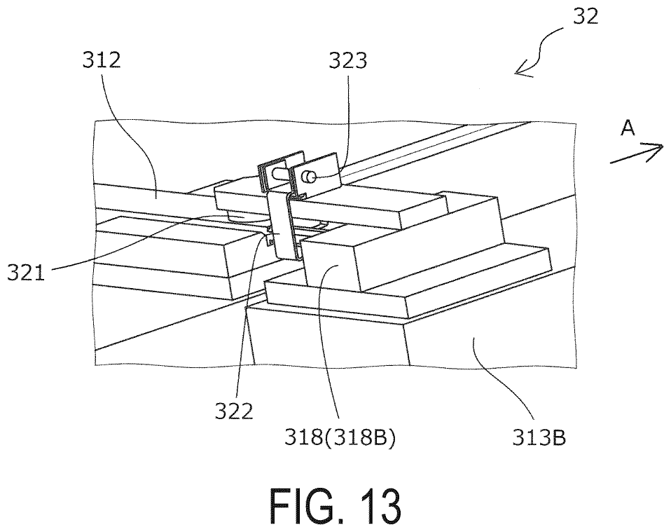

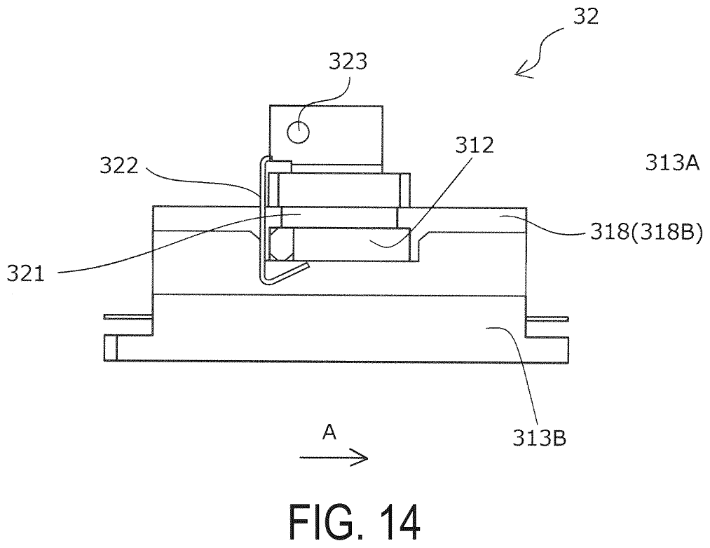

As illustrated in FIG. 12, the dryer 10D of the present example is different in a disposition of the first reflecting plate 21A and the second reflecting plate 21B in a displacement direction, but similarly to the dryer 10C of Example 3, has a configuration in which the engaging portion 30 (an engaging portion 30E) can be delivered from the first engaging portion supporting and moving portion 318A to the second engaging portion supporting and moving portion 318B. Here, a coupling portion 32 is provided at a coupling portion between the first reflecting plate 21A and the second reflecting plate 21B. The coupling portion 32 is provided at the second rail portion 313B, and as illustrated in FIGS. 13 and 14, the coupling portion 32 is provided with a magnet 321 that is magnetically attracted to the base portion 312 which is metal and a hook 322 that can be fixed to the base portion 312.

The hook 322 rotates about a rotary shaft 323, and is displaceable between a fixed position at which the hook 322 can be fixed to the base portion 312, and an open position at which the hook 322 is not fixed to the base portion 312. Note that the configuration has been illustrated in which the second rail portion 313B can be attached to the base portion 312 by the magnet 321 in the present example, but a double-sided tape or the like may be used instead of the magnet 321.

The present disclosure is not limited to the above examples, and various modifications are possible within the scope of the disclosure described in the claims, and these modifications are also included in the scope of the present disclosure.

What is claimed is:

1. A dryer, comprising:
a heating unit configured to heat a medium;
a drying furnace at which the heating unit is disposed and that is configured to dry the medium; and
a transport unit configured to transport the medium in the drying furnace, wherein
the transport unit includes a first support portion that supports the medium at an inlet side end portion in a transport direction of the medium of the drying furnace, a second support portion that supports the medium at an outlet side end portion in the transport direction of the drying furnace, and a third support portion that supports the medium at a position between the first support portion and the second support portion in a transport path of the medium of the drying furnace, and
the third support portion is configured to be movable in a vertical direction.

2. The dryer according to claim 1 comprising a reflecting plate disposed at a position facing the heating unit and configured to reflect heat generated by the heating unit, wherein
the reflecting plate is configured to support the medium.

3. The dryer according to claim 2, comprising;
as the reflecting plate,
a first reflecting plate disposed at a position between the first support portion and the third support portion; and
a second reflecting plate disposed at a position between the third support portion and the second support portion, wherein
at least one of the first reflecting plate and the second reflecting plate is configured to be displaceable according to a position of the third support portion.

4. The dryer according to claim 1 comprising a medium movement assisting portion configured to assist movement of the medium from an inlet side in the transport direction to an outlet side in the transport direction in the drying furnace.

5. The dryer according to claim 3, comprising:
a first medium movement assisting portion configured to assist movement of the medium from the first support portion side to the third support portion side along the first reflecting plate in the drying furnace; and
a second medium movement assisting portion configured to assist movement of the medium from the third support portion side to the second support portion side along the second reflecting plate in the drying furnace, wherein
the first medium movement assisting portion and the second medium movement assisting portion are configured to deliver the medium at a position between the first reflecting plate and the second reflecting plate.

6. The dryer according to claim 3 comprising a medium movement assisting portion configured to assist movement of the medium from an inlet side in the transport direction to an outlet side in the transport direction in the drying furnace, wherein
the first reflecting plate is configured to be disposed to be lowered as viewed from the first support portion side to the third support portion side,
the second reflecting plate is configured to be disposed to be lowered as viewed from the third support portion side to the second support portion side, and
the medium movement assisting portion is configured to be moved from the inlet side in the transport direction to the outlet side in the transport direction by using gravity while holding the medium.

7. The dryer according to claim 1 comprising a heating unit displacement unit configured to displace at least one of a position and posture of the heating unit, wherein
the heating unit displacement unit displaces the heating unit based on a position of the third support portion.

8. The dryer according to claim 1 comprising an exhaust port at the drying furnace, wherein
as the heating unit, a first heating unit located upstream of the exhaust port in the transport direction and a second heating unit located downstream of the exhaust port in the transport direction are included.

9. The dryer according to claim 1 comprising a third support portion position adjustment unit configured to adjust a position of the third support portion in a vertical direction, wherein
the third support portion position adjustment unit adjusts the position of the third support portion in the vertical direction according to a type of the medium.

10. The dryer according to claim 1 comprising a third support portion position adjustment unit configured to adjust a position of the third support portion in a vertical direction, wherein
the third support portion position adjustment unit adjusts the position of the third support portion in the vertical direction according to a transport state of the medium.

11. The dryer according to claim 1, wherein
the drying furnace is provided with a window portion through which the third support portion is visible from outside.

12. The dryer according to claim 10, wherein
the third support portion position adjustment unit performs adjustment such that at least a part of the third support portion is at a position farther from the heating unit when the medium is not transported than when the medium is transported.
